(19) United States
(12) Patent Application Publication
(10) Pub. No.: US 2023/0086627 A1
(43) Pub. Date: Mar. 23, 2023

(54) DISPLAY CONTROL DEVICE, DISPLAY CONTROL METHOD, AND RECORDING MEDIUM HAVING DISPLAY CONTROL PROGRAM RECORDED THEREON

(71) Applicant: HONDA MOTOR CO., LTD., Tokyo (JP)

(72) Inventors: Yusuke Ogura, Tokyo (JP); Hirokazu Aoyama, Tokyo (JP); Hiroto Komuro, Tokyo (JP)

(21) Appl. No.: 17/892,531

(22) Filed: Aug. 22, 2022

(30) Foreign Application Priority Data
Sep. 21, 2021 (JP) 2021-153282

(51) Int. Cl. G06F 3/14; G06F 3/04817; B60K 35/00

(52) U.S. Cl. CPC G06F 3/1423; G06F 3/04817; B60K 35/00; B60K 2370/52; B60K 2370/178; B60K 2370/182; B60K 2370/168; B60K 2370/736

(57) ABSTRACT

A display control device includes: a state acquisition unit that acquires a vehicle state; and a display control unit that when a vehicle state is a warning state requiring a warning to a driver, displays a warning icon on a first display device and displays a type of the warning state and relevant information on a second display device provided closer to a center in a vehicle width direction relative to the first display device.

### INCORPORATION BY REFERENCE

The present application claims priority under 35 U.S.C.§ 119 to Japanese Patent Application No. 2021-153282 filed on Sep. 21, 2021. The content of the application is incorporated herein by reference in its entirety.

### BACKGROUND OF THE INVENTION

### Field of the Invention

The present invention relates to a display control device, a display control method, and a recording medium having a display control program recorded thereon.

### Description of the Related Art

A vehicle display device is disclosed in Japanese Patent Laid-Open No. 2009-40281 that displays a warning icon and text information regarding a vehicle abnormality on a display device that displays meters of a vehicle speed meter and the like. In the vehicle display device, an animation is displayed in which the warning icon approaches a display position of the text information such that a user can easily understand relevance between the warning icon and the text information.

On display devices such as a speed meter and a tachometer installed in front of a driver who sits in a driver's seat to display information related to vehicle traveling, various information are displayed including a temperature of a driving device, the remaining amount of fuel, the remaining charge, fuel consumption, and the amount of oil in a driving system. Additionally, in a case of a vehicle having traveling support functions of ADAS and ACC, information on how these functions are set is also displayed on the display devices.

On the other hand, there are various types of warning information, which should be given to the driver to ensure the safety of the vehicle traveling and the safety of passengers, including a brake system warning, a charging warning, a half-door warning, and a seatbelt non-wearing warning, and thus when detailed contents of these warnings and information on a coping method are included, the information quantity to be displayed to the driver becomes enormous.

When such enormous information is aggregated and displayed on the display devices arranged in front of the driver's seat, information that needs to be frequently checked at the time of traveling is buried in various information displays, whereby the driver's understanding of situations may be hindered. As a countermeasure, it is conceivable to increase the size of the display screen on the display device such that more information can be displayed on the display device in front of the driver's seat, but in this case, power consumption and costs increase.

From the above circumstances, an object of the present invention is to present various warning information to the driver in an easy-to-understand manner without increasing power consumption and costs, while preventing the information display frequently used by the driver at the time of traveling from being buried.

The above object contributes to reduction of road traffic accidents by improving the quality of driving behavior of persons with various characteristics, for example, beginners and experts in vehicle driving who have different degrees of attention at the time of vehicle driving, while reducing energy consumption and improving energy efficiency of society as a whole, and also contributes to the achievement of SDGs and the realization of a sustainable society (SDGs: 3.6, 7.3).

### SUMMARY OF THE INVENTION

A first aspect of the present invention provides a display control device that controls an operation of a first display device provided in front of a driver's seat of a vehicle and an operation of a second display device provided closer to a center in a vehicle width direction of the vehicle relative to the first display device, the display control device including: a state acquisition unit that acquires a vehicle state; and a display control unit that controls the operation of the first display device and the operation of the second display device, in which when the vehicle state acquired by the state acquisition unit is a warning state requiring a warning to a driver, the display control unit is configured to: display, on the first display device, a warning icon indicating that the warning state occurs; and display, on the second display device, a type icon indicating a type of the warning state and information on the warning state.

In the first aspect of the present invention, the display control unit displays the type icon in a first display area on a display screen of the second display device, the first display area being provided along an upper side of the display screen, and displays the information on the warning state in a second display area below the first display area.

In the first aspect of the present invention, the type icon includes a first type icon associated with information to be displayed in the second display area and a second type icon not associated with the information to be displayed in the second display area, and the first type icon and the second type icon are displayed in the first display area in different display modes from each other.

In the first aspect of the present invention, when the first type icon displayed in the first display area is pressed, the display control unit displays information associated with the pressed first type icon in the second display area.

In the first aspect of the present invention, the first type icon is arranged closer to the driver's seat relative to the second type icon in the first display area.

In the first aspect of the present invention, in a case of displaying a text message in the first display area, the display control unit displays the text message at a position closer to the driver's seat relative to a display position of the type icon.

In the first aspect of the present invention, the display control unit displays the information on the warning state to be located closer to the driver's seat in the second display area.

In the first aspect of the present invention, the display control unit displays each of starting buttons used to start operating each of predetermined functions in a third display area arranged closer to the driver's seat relative to the second display area on the display screen of the second display device.

In the first aspect of the present invention, when the vehicle state acquired by the state acquisition unit indicates that a remaining charge of a battery mounted on the vehicle is less than a predetermined value or indicates a breakdown of the second display device, the display control unit stops the display on the second display device and displays the type icon on the first display device.

A second aspect of the present invention provides a display control method to be executed by a display control device that controls an operation of a first display device provided in front of a driver's seat of a vehicle and an operation of a second display device provided closer to a center in a vehicle width direction of the vehicle relative to the first display device, the display control method including: a state acquisition step of acquiring a vehicle state; and a display control step of controlling the operation of the first display device and the operation of the second display device, in which when the vehicle state acquired in the state acquisition step is a warning state requiring a warning to a driver, the display control step includes: displaying, on the first display device, a warning icon indicating that the warning state occurs; and displaying, on the second display device, a type icon indicating a type of the warning state and information on the warning state.

A third aspect of the present invention provides a non-transitory computer-readable recording medium having a display control program recorded thereon, the display control program causing a computer of a display control device, which controls an operation of a first display device provided in front of a driver's seat of a vehicle and an operation of a second display device provided closer to a center in a vehicle width direction of the vehicle relative to the first display device, to function as: a state acquisition unit that acquires a vehicle state; and a display control unit that controls the operation of the first display device and the operation of the second display device, in which when the vehicle state acquired by the state acquisition unit is a warning state requiring a warning to a driver, the display control unit is configured to: display, on the first display device, a warning icon indicating that the warning state occurs; and display, on the second display device, a type icon indicating a type of the warning state and information on the warning state.

According to the aspects of the present invention, it is possible to present various warning information to the driver in an easy-to-understand manner without increasing power consumption and costs, while preventing the information display frequently used by the driver at the time of traveling from being buried.

### BRIEF DESCRIPTION OF THE DRAWINGS

FIG. 1 is a configuration diagram of a vehicle including a display control device according to an embodiment of the present invention;

FIG. 2 is a view showing an example of an arrangement of a display panel and a touch panel in a vehicle interior;

FIG. 3 is a diagram showing a configuration of the display control device;

FIG. 4 is a view showing an example of a warning icon displayed on the display panel by a display control unit;

FIG. 5 is a view showing an example of a display screen displayed on the touch panel by the display control unit;

FIG. 6 is a view showing an example of warning information displayed on the touch panel by the display control unit; and

FIG. 7 is a flowchart showing an example of a procedure of a warning display operation in the display control device.

### DETAILED DESCRIPTION OF THE PREFERRED EMBODIMENT

Hereinafter, an embodiment of the present invention will be described with reference to the drawings.

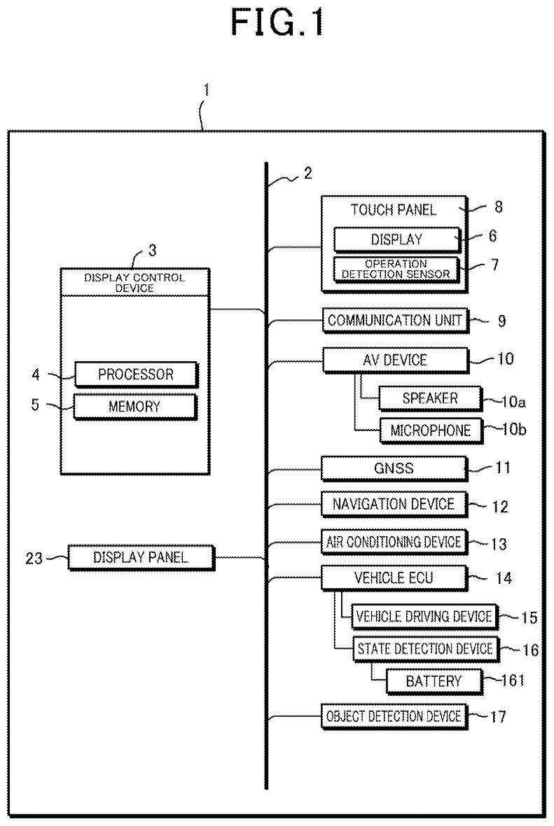

FIG. 1 is a configuration diagram of a vehicle 1 including a display control device 3 of the present embodiment.

The display control device 3 includes a processor 4 and a memory 5. The memory 5 is composed of, for example a volatile and/or non-volatile semiconductor memory and/or a hard disk device. The processor 4 is a computer included in the display control device 3, and is composed of one or a plurality of central processing units (CPUs) or micro processing units (MPUs), for example.

The display control device 3 communicates, via an in-vehicle network 2, with in-vehicle devices of the vehicle 1, for example, a display panel 23, a touch panel 8, a communication unit 9, an AV device 10 (AV: Audio Visual), a GNSS receiver 11 (GNSS: Global Navigation Satellite System), a navigation device 12, an air conditioning device 13, a vehicle ECU 14, and an object detection device 17.

The display panel 23 is formed of, for example an LCD (Liquid Crystal Display). The display panel 23 mainly displays information referred to in a driving operation of the vehicle 1, for example, a vehicle speed of the vehicle 1, a temperature of the vehicle driving device 15, and the remaining charge of a battery 161.

The touch panel 8 includes a display 6 and an operation detection sensor 7. The display 6 is formed of an LCD or the like. Further, the operation detection sensor 7 is a touch sensor that is provided on a surface of the display 6 to detect a user's touch operation.

The communication unit 9 includes a wireless device conforming to a communication standard of a mobile communication system and a short-range wireless device conforming to a near-field communication standard such as Bluetooth (registered trademark).

The AV device 10 reproduces music and moving images using a display 6 and a speaker 10a of the touch panel 8 according to the related art, communicates with a mobile terminal such as a smartphone existing in the interior of the vehicle 1, and provides a hands-free call function by the speaker 10a and a microphone 10b when there is an incoming call to the mobile terminal.

The GNSS receiver 11 detects a position of the vehicle 1.

The navigation device 12 executes a route search to a destination designated by an operation of the touch panel 8, and displays a map and the position of vehicle 1 on the display 6 to perform route guidance, for example.

The air conditioning device 13 adjusts temperature and/or humidity in the interior of the vehicle 1.

The vehicle ECU 14 is an electronic control unit (ECU) that controls various operations of the vehicle 1. The vehicle 1 may include a plurality of ECUs. The vehicle ECU 14 schematically shows such a plurality of ECUs. For example, the ECU in the vehicle 1 includes an ECU that controls an operation of a vehicle driving device 15 such as a motor or an engine. Further, the ECU in the vehicle 1 includes an ECU that detects a state of the vehicle 1 based on sensor information from a state detection device 16 and outputs state information. The state of the vehicle may include, for example, a motion state of the vehicle 1 such as speed, a charge state of the in-vehicle battery 161, or an operation state of an accelerator pedal and the like).

The state detection device 16 includes a sensor that detects a vehicle state related to a traveling operation of the vehicle 1 and a sensor that detects a state of an occupant. The sensor configured to detect the vehicle state related to the traveling operation may include a vehicle speed sensor, a steering angle sensor, an accelerator pedal sensor, a brake pedal sensor, a voltage sensor and a current sensor provided in the battery 161 and the like. The sensor configured to detect the state of the occupant may include seatbelt switches, seat occupancy sensors, in-vehicle cameras and the like.

The object detection device 17 detects an object existing around the vehicle 1 with an outside-vehicle camera, a radar, a rider, or a sonar, and outputs detection information to another in-vehicle device.

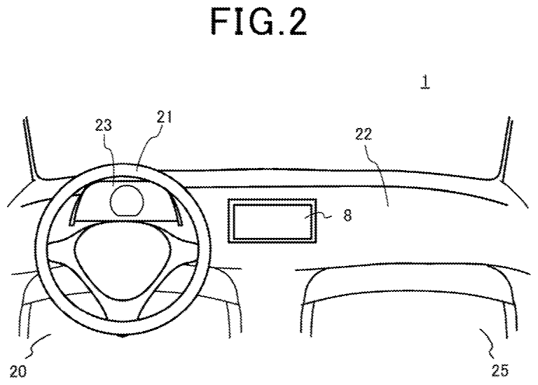

FIG. 2 is a view showing an example of an arrangement of the display panel 23 and the touch panel 8 in the interior of the vehicle 1. In the present embodiment, the vehicle 1 is a so-called left-hand drive vehicle in which a driver's seat 20 and a steering wheel 21 are on a left side in a forward advancing direction. The display panel 23 is arranged at a position in front of the driver's seat 20 on the instrument panel 22 to display various instruments including a speed meter. The display panel 23 corresponds to a first display device.

On the instrument panel 22, the touch panel 8 is arranged closer to a center in a vehicle width direction relative to the display panel 23 (hence, on a side of the passenger seat 25). The touch panel 8 corresponds to a second display device. The touch panel 8 is a display device such as a so-called display/audio which is usually provided in a passenger car.

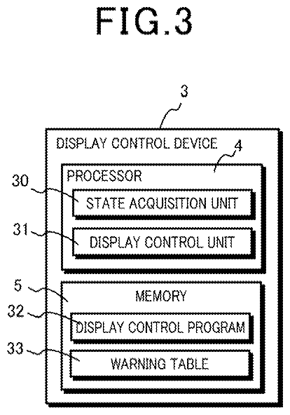

FIG. 3 is a diagram showing a functional configuration of the display control device 3. The display control device 3 controls an operation of the display panel 23 which is the first display device provided in front of the driver's seat of the vehicle 1 and an operation of the touch panel 8 which is the second display device provided closer to the center in the vehicle width direction of the vehicle 1 relative to the display panel 23.

The processor 4 includes, as functional components or functional units, a state acquisition unit 30 and a display control unit 31. These functional components in the processor 4 are realized when the processor 4 as a computer executes a display control program 32 which is a computer program stored in the memory 5. Alternatively, all or part of the functional components included in the processor 4 may be composed of hardware including one or more electronic circuit components. The display control program 32 can be stored in any computer-readable storage medium such as an optical disk, a magnetic disk, and a flash memory.

The state acquisition unit 30 acquires a state of the vehicle 1 (hereinafter, also referred to as a vehicle state), which is detected by the state detection device 16 in the vehicle ECU 14, via the in-vehicle network 2. Further, the state acquisition unit 30 determines according to the related art whether the acquired vehicle state is a warning state requiring a warning to the driver.

The display control unit 31 controls the operations of the display panel 23, which is the first display device, and the touch panel 8 which is the second display device. The display control unit 31 displays, on the display panel 23, information related to the vehicle speed, the remaining amount of the battery 161, the temperature of the vehicle driving device 15, the remaining amount of oil in the driving force transmission system, and the outdoor air temperature, based on the vehicle state acquired by the state acquisition unit 30.

Further, the display control unit 31 controls the operation of the touch panel 8 in cooperation with other in-vehicle devices connected to the in-vehicle network 2, and displays information necessary for the operation of these in-vehicle devices on the touch panel 8. Further, the display control unit 31 acquires an input from the user for these in-vehicle device from the touch panel 8, and transmits it to the corresponding in-vehicle device.

In the present embodiment, in particular, when the vehicle state acquired by the state acquisition unit 30 is a warning state requiring a warning to the driver, the display control unit 31 displays, on the display panel 23 as the first display device, a warning icon indicating the warning state occurs, and displays, on the touch panel 8 as the second display device, a type icon indicating a type of the warning state and information regarding the warning state.

Specifically, on the display screen of the touch panel 8, the display control unit 31 displays the type icon in a first display area along an upper side of the display screen, and displays the information regarding the warning state (hereinafter, also referred to as warning information) in a second display area below the first display area. The second display area is a general-purpose display area, and can be used to display buttons for starting operating various functions and to display a video or images such as photographs.

In order to display the type icon and the warning information, the memory 5 stores in advance a warning table 33 in which the warning state, the type icon, and the warning information are associated with each other. The warning table 33 may further store a pictogram indicating a coping method for canceling the warning or a simple warning message in association with the type icon. When the vehicle state acquired by the state acquisition unit 30 is a warning state requiring a warning to the driver, the display control unit 31 refers to the warning table 33 and displays the type icon corresponding to the warning state and the warning information on the touch panel 8.

The type icon includes, for example, a first type icon associated with the information to be displayed in the second display area and a second type icon not associated with the information to be displayed in the second display area. Here, the information to be displayed in the second display area is, for example, warning information. The display control unit 31 displays the first type icon and the second type icon in the first display area in different display modes. When the first type icon displayed in the first display area is pressed, the display control unit 31 displays, in the second display area, information associated with the pressed first type icon.

The display control unit 31 also provides a third display area at a position closer to the driver's seat relative to the second display area on the display screen of the touch panel 8, and may display, in the third display area, starting buttons used to start operating predetermined functions.

Further, the display control unit 31 stops the display on the touch panel 8 and displays the type icon on the display panel 23 being the first display device when the vehicle state acquired by the state acquisition unit 30 indicates that the remaining charge of the battery 161 of the vehicle 1 (for example, SOC: State Of Charge) is less than a predetermined value or indicates a breakdown of the touch panel 8 which is the second display device.

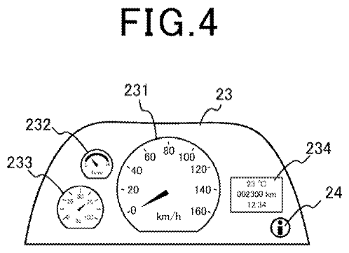

FIG. 4 shows an example of a warning icon displayed on the display panel 23 by the display control unit 31. The display control unit 31 displays a warning icon at a predetermined position on the display panel 23, for example. In the shown example, on the display panel 23, a speed meter 231, a thermometer 232 indicating a temperature of the vehicle driving device 15, a charging meter 233 indicating the remaining charge of the battery 161, and an information display portion 234 indicating information on a time is shown. Then, a warning icon 24 surrounding a character “i” by a circle is displayed on a lower right side of the display panel 23, that is, on a side on which the touch panel 8 being the second display device is located.

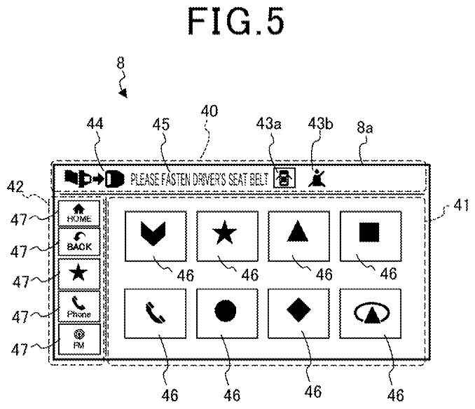

FIG. 5 shows an example of a display screen displayed on the touch panel 8 by the display control unit 31. A first display area 40 is provided along an upper side 8a of the display screen of the touch panel 8, and a second display area 41 is provided below the first display area 40 (both areas being within a rectangular frame shown by a dotted line). Further, a third display area 42 is provided at a position closer to the driver's seat 20 relative to the second display area 41.

In the first display area 40, type icons 43a and 43b indicating a half-door warning and a seatbelt warning which are current warning states are shown. In the shown example, the type icon 43a is a first type icon associated with the information to be displayed in the second display area 41, and the type icon 43b is a second type icon not associated with the information to be displayed in the second display area 41. The type icon 43a being the first type icon is displayed in a manner of being surrounded by a frame line, which is different from the type icon 43b being the second type icon. Hereinafter, type icons including the type icons 43a and 43b displayed in the first display area 40 are collectively also referred to as a type icon 43.

On a left side of the type icons 43a and 43b in the first display area 40, a pictogram 44 associated with the type icon 43b and a simple warning message 45 “Please fasten a driver's seat belt” are also shown.

In the second display area 41 shown in FIG. 5, various buttons 46 are displayed to access various functions such as a phone function and a route guidance function. When the user performs a swiping operation in the second display area 41, for example, buttons, which cannot be displayed all at once in a space of the second display area 41, is displayed.

In the third display area 42, for example, buttons 47 to be frequently used is displayed. These buttons 47 may include a home button for returning the display in the second display area 41 to the default state, a back button for returning to an immediately preceding screen, and shortcut buttons corresponding to the buttons 46 displayed in the second display area 41.

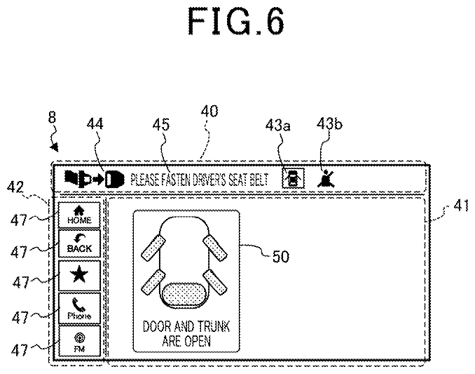

When the user presses (or taps) the type icon 43a, which is the first type icon, on the display screen shown in FIG. 5, as shown in FIG. 6, the display control unit 31 does not displays the buttons 46 but displays warning information 50 associated with the type icon 43a in the second display area 41.

Since the first type icon is a target of pressing or tapping by the user when the warning information 50 is displayed in the second display area 41, the first type icon is preferably arranged at a position closer to the driver's seat relative to the second type icon as in the type icon 43a shown in FIG. 6.

Further, when a text message such as the warning message 45 is displayed in the first display area 40, the text message is preferably displayed closer to the driver's seat 20 relative to the type icon 43 such that the movement of the driver's line of sight is shortened from the front field of view of the vehicle 1. For the same reason, the warning information 50 is preferably displayed closer to the driver's seat 20 in the second display area 41.

The display control device 3 having the above configuration displays the warning icon on the display panel 23 arranged in front of the driver's seat 20 when a warning state requiring a warning to the driver occurs in the vehicle 1. Then, the display control device 3 displays the type icon 43 indicating a type of the warning state and the warning information 50 on the touch panel 8.

In other words, the display control device 3 does not display the information on the warning state on the display panel 23 having an enlarged size, but displays the information on the warning state on the touch panel 8 such as a display/audio usually provided in the passenger car. Therefore, it is possible to present various warning information to the driver in an easy-to-understand manner without increasing power consumption and costs, while preventing the information display frequently used by the driver at the time of traveling from being buried.

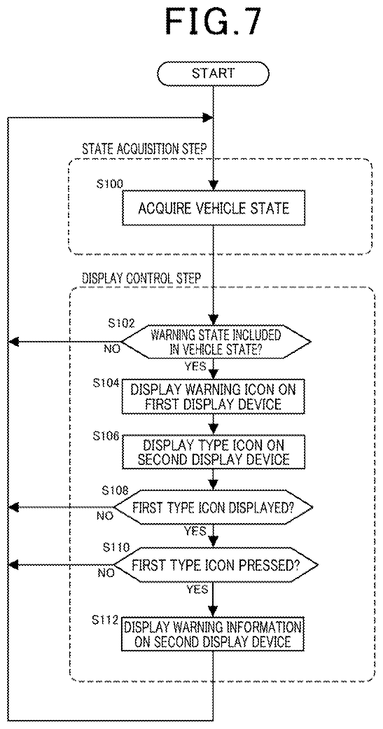

Next, a description is given with respect to a procedure of an operation of displaying the information regarding the warning state of the vehicle 1 (hereinafter, referred to as a warning display operation) in the display control device 3. FIG. 7 is a flowchart showing an example of a procedure of a warning display operation in the display control device 3. The process in FIG. 7 starts when the display control device 3 is powered on. Further, the process in FIG. 7 ends when the display control device 3 is powered off. In FIG. 7, step S100 corresponds to a state acquisition step, and steps S102 to S112 correspond to a display control step.

When the process is started, the state acquisition unit 30 of the display control device 3 acquires the vehicle state detected using the state detection device 16 by the vehicle ECU 14 via the in-vehicle network 2 (S100). The state acquisition unit 30 determines whether the acquired vehicle state includes a warning state that requires a warning to the driver (S102). Then, when the vehicle state does not include the warning state (NO in S102), the display control unit 31 returns the process to step S100. At this time, when the warning icon 24 is already displayed on the display panel 23, the display control unit 31 erases the warning icon 24, and when the type icon 43 and the warning information 50 are already displayed on the touch panel 8, the display control unit 31 erases all these displays.

On the other hand, when the vehicle state includes at least one warning state (YES in S102), the state acquisition unit 30 notifies the display control unit 31 of such a warning state. Upon receiving the notification of the warning state, the display control unit 31 displays the warning icon 24 on the display panel 23 which is the first display device (S104) when the warning icon 24 is not yet displayed on the display panel 23. Further, the display control unit 31 refers to the warning table 33 retained in the memory 5, and displays the type icon 43 corresponding to each of the warning states described above in the first display area 40 of the touch panel 8 (S106), which is the second display device, when the type icon 43 corresponding to each of the warning states described above is not yet displayed on the touch panel 8.

When there is the pictogram 44 and/or the warning message 45 associated with the warning state in the warning table 33, the display control unit 31 also displays the pictogram 44 and/or the warning message 45 in the first display area 40. In this case, when a plurality of warning states occur at the same time, the display control unit 31 can display, on the touch panel 8, the pictogram 44 and/or the warning message corresponding to these warning states, for example, in a manner of being capable of being displayed sequentially on the screens shown in FIGS. 5 and 6 by a swiping operation in an up-down direction.

In a case of displaying the type icon 43 in step S106, when the vehicle state acquired by the state acquisition unit 30 in step S100 does not include the warning state corresponding to the type icon 43 and/or the warning information 50 already displayed on the touch panel 8, the display control unit 31 erases the display of the type icon 43 and the warning information 50 from the touch panel 8.

Next, the display control unit 31 determines whether the first type icon (for example, the type icon 43a shown in FIG. 5) is displayed in the first display area 40 (S108). Then, when the first type icon is not displayed (NO in S108), the process returns to step S100 and the display control unit 31 repeats the process. On the other hand, when the first type icon is displayed (YES in S108), the display control unit 31 determines whether any of the first type icons is pressed (S110).

Then, when it is determined in step S110 that the first type icon is not pressed (NO in S110), the process returns to step S100 and the display control unit 31 repeats the process. On the other hand, when it is determined that any of the first type icons is pressed (YES in S110), the display control unit 31 refers to the warning table 33 of the memory 5, and when the warning information 50 associated with the pressed first type icon is not yet displayed on the touch panel 8, the display control unit 31 displays the warning information 50 in the second display area 41 on the touch panel 8 (S112). Then, the display control unit 31 returns the process to step S100.

The present invention is not limited to the configuration of the above embodiment, and can be implemented in various aspects without departing from the gist thereof.

For example, the size of the first display area 40 is not described in the present embodiment described above, but may be a fixed size, or may be dynamically changed depending on the number of displayed type icons 43, the number of pictograms 44, and/or the number of warning messages 45.

Further, the size of the warning information 50 or the information quantity is described as being within the size of the second display area 41 at one time in the above-described embodiment, but is not limited thereto. When a part of the warning information 50 is displayed in the second display area 41 and the user performs a swiping operation on the second display area 41, the other parts of the warning information 50 may be displayed in the second display area 41.

Further, when the type icon 43 is displayed in the first display area 40, a message for operation support such as an “a warning content is displayed when the icon with a frame is touched” may be displayed in the second display area 41.

The above embodiment supports the following configurations.

(Configuration 1) A display control device that controls an operation of a first display device provided in front of a driver's seat of a vehicle and an operation of a second display device provided closer to a center in a vehicle width direction of the vehicle relative to the first display device, the display control device including: a state acquisition unit that acquires a vehicle state; and a display control unit that controls the operation of the first display device and the operation of the second display device, in which when the vehicle state acquired by the state acquisition unit is a warning state requiring a warning to a driver, the display control unit is configured to: display, on the first display device, a warning icon indicating that the warning state occurs; and display, on the second display device, a type icon indicating a type of the warning state and information on the warning state.

According to the display control device of Configuration 1, since the information on the warning state is displayed using the plurality of display devices normally provided in the vehicle without requiring an increase in the display area of the display devices, it is possible to present various warning information to the driver in an easy-to-understand manner without increasing power consumption and costs, while preventing the information display frequently used by the driver at the time of traveling from being buried.

(Configuration 2) In the display control device according to Configuration 1, the display control unit displays the type icon in a first display area on a display screen of the second display device, the first display area being provided along an upper side of the display screen, and displays the information on the warning state in a second display area below the first display area.

According to the display control device of Configuration 2, since the type icon is displayed in the first display area along the upper side of the display screen where the user's line of sight is easily guided, the user can immediately grasp the type of the warning state after recognizing that the warning state occurs by the warning icon displayed on the first display device. Further, since the user can visually recognize the warning information displayed in the second display area with ease by slightly shifting the line of sight after seeing the type icon in the first display area, the user can grasp the information on the warning state with a smooth operation.

(Configuration 3) In the display control device according to Configuration 2, the type icon includes a first type icon associated with information to be displayed in the second display area and a second type icon not associated with the information to be displayed in the second display area, and the first type icon and the second type icon are displayed in the first display area in different display modes from each other.

According to the display control device of Configuration 3, since the warning state can be displayed with the second type icon such that the content of the warning can be delivered to the driver with only a simple display and the warning state can be displayed with the first type icon such that more display information needs to be used, the driver can easily grasp the information quantity necessary for understanding the warning content only by looking at the type icon.

(Configuration 4) In the display control device according to Configuration 3, when the first type icon displayed in the first display area is pressed, the display control unit displays information associated with the pressed first type icon in the second display area.

According to the display control device of Configuration 4, since the warning information associated with the first type icon is first displayed in the second display area when the first type icon is pressed, the driver who can fully grasp the warning content only by looking at the first type icon can acquire other information from the second display area without being troubled by the display of the known information.

(Configuration 5) In the display control device according to Configuration 3 or 4, the first type icon is arranged closer to the driver's seat relative to the second type icon in the first display area.

According to the display control device of Configuration 5, the driver can easily operate the first type icon to display necessary warning information in the second display area.

(Configuration 6) In the display control device according to any one of Configurations 2 to 5, in a case of displaying a text message in the first display area, the display control unit displays the text message at a position closer to the driver's seat relative to a display position of the type icon.

According to the display control device of Configuration 6, the driver can read the text message displayed in the first display area, with less line-of-sight movement while keeping eyes forward of the vehicle.

(Configuration 7) In the display control device according to any one of Configurations 2 to 6, the display control unit displays the information on the warning state to be located closer to the driver's seat in the second display area.

According to the display control device of Configuration 7, the driver can read the warning information displayed in the second display area, with less line-of-sight movement while keeping eyes forward of the vehicle.

(Configuration 8) In the display control device according to any one of Configurations 2 to 7, the display control unit displays each of starting buttons used to start operating each of predetermined functions in a third display area arranged closer to the driver's seat relative to the second display area on the display screen of the second display device.

According to the display control device of Configuration 8, even when the warning information is displayed on the second display device, it is possible to easily operate the button to start operating the desired function.

(Configuration 9) In the display control device according to any one of Configurations 1 to 8, when the vehicle state acquired by the state acquisition unit indicates that a remaining charge of a battery mounted on the vehicle is less than a predetermined value or indicates a breakdown of the second display device, the display control unit stops the display on the second display device and displays the type icon on the first display device.

According to the display control device of Configuration 9, when the remaining charge of the in-vehicle battery is low, the operation of the second display device is stopped, and at least the type of the warning state is notified to the driver by the type icon displayed on the first display device, whereby it is possible to avoid a situation in which the content of the warning state is not delivered to the driver at all, while reducing power consumption.

(Configuration 10) A display control method to be executed by a display control device that controls an operation of a first display device provided in front of a driver's seat of a vehicle and an operation of a second display device provided closer to a center in a vehicle width direction of the vehicle relative to the first display device, the display control method including: a state acquisition step of acquiring a vehicle state; and a display control step of controlling the operation of the first display device and the operation of the second display device, in which when the vehicle state acquired in the state acquisition step is a warning state requiring a warning to a driver, the display control step includes: displaying, on the first display device, a warning icon indicating that the warning state occurs; and displaying, on the second display device, a type icon indicating a type of the warning state and information on the warning state.

According to the display control method of Configuration 10, since the information on the warning state is displayed using the plurality of display devices normally provided in the vehicle without requiring an increase in the display area of the display devices, it is possible to present various warning information to the driver in an easy-to-understand manner without increasing power consumption and costs, while preventing the information display frequently used by the driver at the time of traveling from being buried.

(Configuration 11) A non-transitory computer-readable recording medium having a display control program recorded thereon, the display control program causing by a computer of a display control device, which controls an operation of a first display device provided in front of a driver's seat of a vehicle and an operation of a second display device provided closer to a center in a vehicle width direction of the vehicle relative to the first display device, to function as: a state acquisition unit that acquires a vehicle state; and a display control unit that controls the operation of the first display device and the operation of the second display device, in which when the vehicle state acquired by the state acquisition unit is a warning state requiring a warning to a driver, the display control unit is configured to: display, on the first display device, a warning icon indicating that the warning state occurs; and display, on the second display device, a type icon indicating a type of the warning state and information on the warning state.

According to the display control program recorded on the recording medium of Configuration 11, an increase in the display area of the display devices is unnecessary by the computer of the display control device, and thus it is possible to present various warning information to the driver in an easy-to-understand manner without increasing power consumption and costs, while preventing the information display frequently used by the driver at the time of traveling from being buried.

### REFERENCE SIGNS LIST

1 vehicle
2 in-vehicle network
3 display control device
4 processor
5 memory
6 display
7 operation detection sensor
8 touch panel
8a upper side
9 communication unit
10 AV device
10a speaker
10b microphone
11 GNSS receiver
12 navigation device
13 air conditioning device
14 vehicle ECU
15 vehicle driving device
16 state detection device
161 battery
17 object detection device
20 driver's seat
21 steering wheel
22 instrument panel
23 display panel
231 speed meter
232 thermometer
233 charging meter
234 information display portion
24 warning icon
25 passenger seat
30 state acquisition unit
31 display control unit
32 display control program
33 warning table
40 first display area
41 second display area
42 third display area
43, 43a, 43b type icon
44 pictogram
45 warning message
46, 47 button
50 warning information

What is claimed is:

1. A display control device that controls an operation of a first display device provided in front of a driver's seat of a vehicle and an operation of a second display device provided closer to a center in a vehicle width direction of the vehicle relative to the first display device, the display control device comprising:
a state acquisition unit that acquires a vehicle state; and
a display control unit that controls the operation of the first display device and the operation of the second display device, wherein
when the vehicle state acquired by the state acquisition unit is a warning state requiring a warning to a driver, the display control unit is configured to:
display, on the first display device, a warning icon indicating that the warning state occurs; and
display, on the second display device, a type icon indicating a type of the warning state and information on the warning state.

2. The display control device according to claim 1, wherein
the display control unit displays the type icon in a first display area on a display screen of the second display device, the first display area being provided along an upper side of the display screen, and displays the information on the warning state in a second display area below the first display area.

3. The display control device according to claim 2, wherein
the type icon includes a first type icon associated with information to be displayed in the second display area and a second type icon not associated with the information to be displayed in the second display area, and
the first type icon and the second type icon are displayed in the first display area in different display modes from each other.

4. The display control device according to claim 3, wherein
when the first type icon displayed in the first display area is pressed, the display control unit displays information associated with the pressed first type icon in the second display area.

5. The display control device according to claim 3, wherein
the first type icon is arranged closer to the driver's seat relative to the second type icon in the first display area.

6. The display control device according to claim 2, wherein
in a case of displaying a text message in the first display area, the display control unit displays the text message at a position closer to the driver's seat relative to a display position of the type icon.

7. The display control device according to claim 2, wherein
the display control unit displays the information on the warning state to be located closer to the driver's seat in the second display area.

8. The display control device according to claim 2, wherein
the display control unit displays each of starting buttons used to start operating each of predetermined functions in a third display area arranged closer to the driver's seat relative to the second display area on the display screen of the second display device.

9. The display control device according to claim 1, wherein
when the vehicle state acquired by the state acquisition unit indicates that a remaining charge of a battery mounted on the vehicle is less than a predetermined value or indicates a breakdown of the second display device,
the display control unit stops the display on the second display device and displays the type icon on the first display device.

10. A display control method to be executed by a display control device that controls an operation of a first display device provided in front of a driver's seat of a vehicle and an operation of a second display device provided closer to a center in a vehicle width direction of the vehicle relative to the first display device, the display control method comprising:
a state acquisition step of acquiring a vehicle state; and
a display control step of controlling the operation of the first display device and the operation of the second display device, wherein
when the vehicle state acquired in the state acquisition step is a warning state requiring a warning to a driver, the display control step includes:
displaying, on the first display device, a warning icon indicating that the warning state occurs; and
displaying, on the second display device, a type icon indicating a type of the warning state and information on the warning state.

11. A non-transitory computer-readable recording medium having a display control program recorded thereon, the display control program causing a computer of a display control device, which controls an operation of a first display device provided in front of a driver's seat of a vehicle and an operation of a second display device provided closer to a center in a vehicle width direction of the vehicle relative to the first display device, to function as:
a state acquisition unit that acquires a vehicle state; and
a display control unit that controls the operation of the first display device and the operation of the second display device, wherein
when the vehicle state acquired by the state acquisition unit is a warning state requiring a warning to a driver, the display control unit is configured to:
display, on the first display device, a warning icon indicating that the warning state occurs; and
display, on the second display device, a type icon indicating a type of the warning state and information on the warning state.
